(19) United States
(12) Patent Application Publication
(10) Pub. No.: US 2004/0146088 A1
(43) Pub. Date: Jul. 29, 2004

(54) Patty temperature probe

(75) Inventors: Jorge M. Parra, Deland, FL (US); Scott C. Cutright, Gainesville, FL (US)

Correspondence Address: ALIX YALE & RISTAS LLP, 750 MAIN STREET, SUITE 1400, HARTFORD, CT, 06103, US

(73) Assignee: Atkins Technical Inc.

(21) Appl. No.: 10/352,459

(22) Filed: Jan. 27, 2003

(51) Int. Cl. G01K 7/00

(52) U.S. Cl. 374/179

(57) ABSTRACT

A patty temperature probe includes a handle having oppositely disposed proximal and distal ends and a shaft member having oppositely disposed proximal and distal end portions and a longitudinally extending bore, the proximal end portion of the shaft member being mounted to the distal end of the handle. A thermocouple including a sheath having a pointed, solid tip, extends from the distal end portion of the shaft member. The thermocouple junction is disposed within the sheath, with the metallic wires extending from the sheath through the bore of the shaft member to an electrical connector. A V-shaped depth stop includes a foot segment and a mounting segment extending from the foot segment. The mounting segment is mounted to the distal end portion of the shaft member, with the thermocouple extending through an opening in the foot segment. The outer surface of the sheath and the inner surface of the opening defining an annular gap.

### BACKGROUND OF THE INVENTION

This invention relates generally to apparatus for monitoring the internal temperature of foods. More particularly, the present invention relates to apparatus for sensing the internal temperature of an object being cooked, such as a meat patty, so that such object can be monitored for the proper degree of doneness or of temperature elevation.

It is well known that in food preparation sufficient thermal exposure is necessary so as to exceed the thermal death time of disease causing microorganisms and, in doing so, comply with recommended health standards. The commonest disease causing bacteria are a group of anaerobic gram-negative bacteria, including the genera salmonella, shigella and Klebsiella. Of these, salmonella is most commonly found in foodstuffs, namely eggs and egg products, poultry, and meat products, particularly ground meats.

To date few satisfactory tools have been developed to monitor the internal temperature of a food item to ensure that the item is cooked to the proper degree of doneness. Such conventional tools generally fall into one of two categories. The first category is defined by relatively simple temperature sensing devices that provide little or no control of the depth at which the temperature is sensed. The second category is defined by relatively complex temperature sensing devices that include means for controlling the depth at which the temperature is sensed. Unfortunately, the complexity of the devices in this second category make them difficult to clean and relatively expensive.

### SUMMARY OF THE INVENTION

Briefly stated, the invention in a preferred form is a patty temperature probe which comprises a handle having oppositely disposed proximal and distal ends. A shaft member has oppositely disposed proximal and distal end portions and a longitudinally extending bore. The proximal end portion of the shaft member is mounted to the distal end of the handle. A thermocouple including a sheath having a pointed, solid tip, extends from the distal end portion of the shaft member. A thermocouple wire is composed of two dissimilar metallic wires joined at a thermocouple junction. The thermocouple junction is disposed within the sheath, with the metallic wires extending from the sheath through the bore of the shaft member to an electrical connector. A V-shaped depth stop includes a foot segment and a mounting segment extending at an angle from the foot segment. The mounting segment is mounted to the distal end portion of the shaft member, with the thermocouple extending through an opening in the foot segment. The outer surface of the sheath and the inner surface of the opening defining an annular gap.

The shaft member includes a cylindrical shaft segment having oppositely disposed proximal and distal ends and a frustoconical-shaped tip segment extending from the distal end of the shaft segment. A bore extends longitudinally from the distal end of the handle and the proximal end of the shaft segment is fixedly mounted within a distal end portion of the handle bore. The shaft member is sealed to the handle to prevent the intrusion of solids or liquids into the handle bore.

The sheath of the thermocouple extends from the tip segment of the shaft member. A proximal end portion of the sheath is received within the bore of the shaft member at the tip segment and the sheath is mounted to the tip segment by a silver braze.

The mounting segment of the depth stop also has an opening, with the distal end portion of the shaft segment and the tip segment extending through the opening in the mounting segment. The opening in the mounting segment may have an elliptical shape and a notch for receiving the distal end portion of the shaft segment proximate to the tip segment. The depth stop is mounted to the shaft segment by a silver braze.

The thermocouple is a grounded tip thermocouple, a portion of the material of the tip of the sheath commingling with a portion of the material of the thermocouple junction. Preferably, the thermocouple is a type K thermocouple. The sheath has an outside diameter of less than 0.050 inches. The opening in the foot segment is substantially circular, the thermocouple extending through an axis of the opening in the foot segment such that the tip of the thermocouple is positioned at a predetermined distance D_{c} from an outer surface of the foot segment. The angle between the foot segment and the mounting segment is 45 to 135°.

It is also an object of the invention to provide a patty temperature probe having a fixed depth stop which consistently positions the thermocouple tip at the center of the patty.

It is further an object of the invention to provide a patty temperature probe which is simple in construction and easy to clean.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is perspective view of a patty temperature probe in accordance with the invention;

FIG. 2 is an enlarged perspective view of the tip portion of the patty temperature probe of FIG. 1;

FIG. 3 is an enlarged side view of the depth stop of the patty temperature probe of FIG. 1;

FIG. 4 is a top view of the depth stop of FIG. 3;

FIG. 5 is a front view of the depth stop of FIG. 3; and

FIG. 6 is an enlarged side view of the tip portion of the patty temperature probe of FIG. 1.

### DETAILED DESCRIPTION OF THE PREFERRED EMBODIMENT

With reference to the drawings wherein like numerals represent like parts throughout the several figures, a patty temperature probe in accordance with the present invention is generally designated by the numeral 10.

It has long been known that certain foods must be exposed to a sufficient amount of heat to ensure that any disease causing microorganisms contained therein are destroyed. Recent instances of salmonella or E. coli poisoning related to undercooked food products have resulted in the tightening of health standards governing the preparation and serving of such food products and the adoption new practices intended to implement such standards. One such new practice is Hazard Analysis Critical Control Points (HACCP). HACCP is a guideline that can minimize the actual risk of acquiring a food-borne illness. It was developed by NASA to keep astronauts from getting sick in space. Most Health Departments are requesting restaurants and food processors to comply with these guidelines.

As a consequence of the implementation of these new standards and practices, the need for devices capable of accurately measuring the internal temperature of food products has grown. Conventional temperature measuring devices, such as meat thermometers, may be sufficient to meet the needs of restaurants where the food is prepared and cooked to order. Many such restaurants compete on the basis of the quality of their food. Consequently, the food is prepared by trained chefs who ensure that the food is properly prepared. However, where large volumes of food are rapidly prepared in an assembly-line manner (e.g. the fast food industry), such conventional devices are simply inadequate.

Due to the rate of throughput, there is simply less time which may be spent on the preparation any one food item. Consequently, there is less time to ensure that the food is properly prepared. Generally, the pay for the food preparers is low. Accordingly, the personnel preparing the food are very often young and lacking in job skills and experience. There is generally a large turnover of personnel in this industry and training is minimal. Therefore, there is little opportunity to evaluate personnel performance or to correct deficiencies in performance.

Fortunately, establishments preparing assembly-line food generally have relatively simple, limited menus, thereby limiting the variety and complexity of food preparation techniques which must be learned. In addition, the raw materials used in these establishments are to a large extent pre-prepared to explicit specifications. For example, beef patties are not prepared from bulk ground beef at these establishments. Instead, the patties are pre-made at a supplier and frozen prior to delivery. Each of the beef patties in a given product line has substantially identical dimensions and weight to ensure that the patties are all identically cooked in the time allotted by the “assembly-line”.

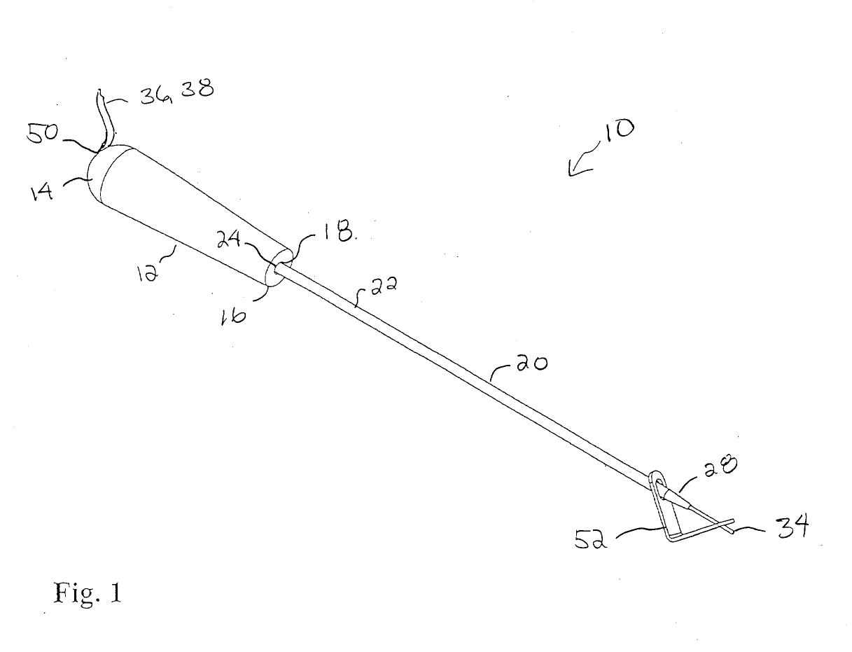

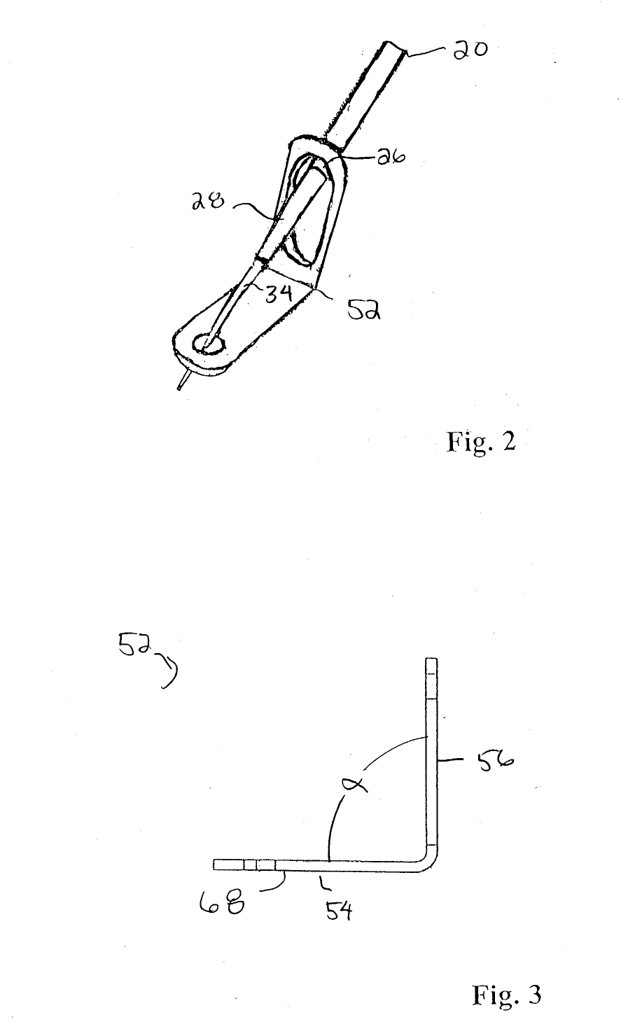

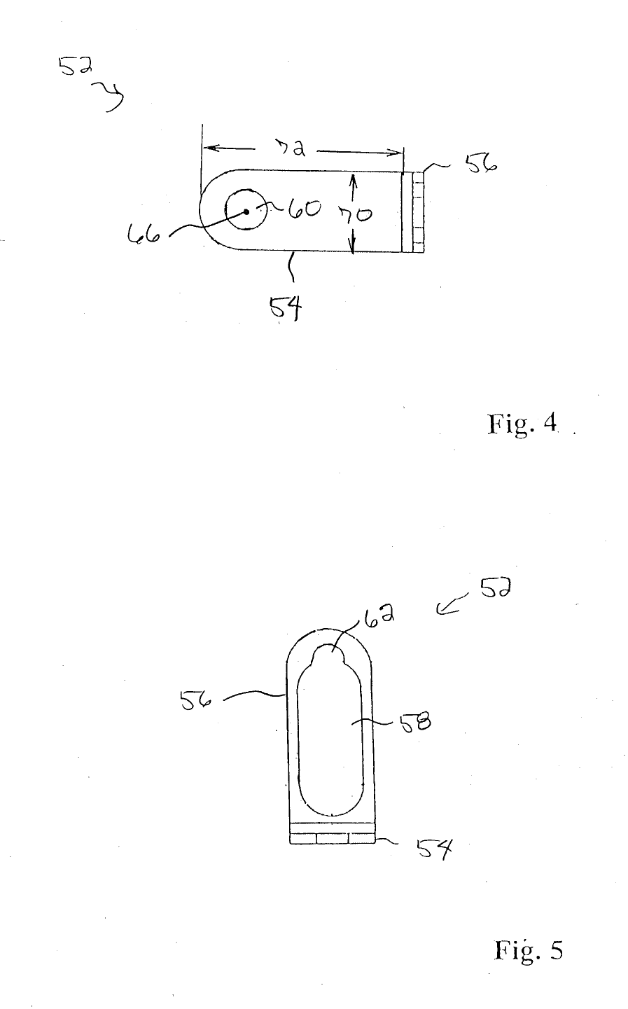

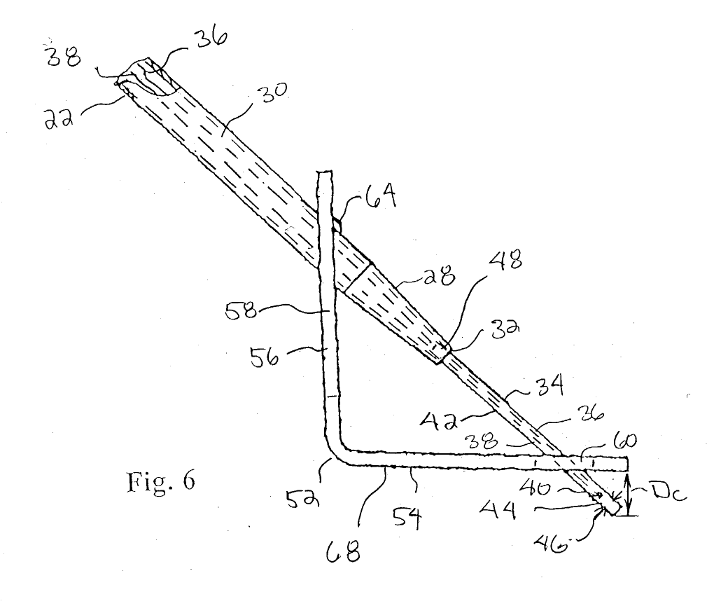

A patty temperature probe 10 in accordance with the invention includes a handle 12 which extends longitudinally from a bulbous proximal end 14 to a flattened distal end 16, providing a hilt for grasping the probe 10 (FIG. 1). The handle 12 is composed of a heat resistant, water impervious material and has a bore 18 which extends longitudinally therewithin. A shaft member 20 includes a cylindrical shaft segment 22 having oppositely disposed proximal and distal ends 24, 26 and a frustoconical-shaped tip segment 28 extending from the distal end 26 of the shaft segment 22. Preferably, the shaft member 20 is composed of type 304 stainless steel, which is food service approved. A bore 30 (FIG. 6) extends longitudinally from the proximal end 24 of the shaft segment 22 to the distal end 32 of the tip segment 28. The proximal end 24 of the shaft segment 22 is fixedly mounted within the distal end portion of the handle bore 18. The shaft member 20 is sealed to the handle 12 to prevent the intrusion of solids or liquids into the handle bore 18 through the opening in the distal end 16 of the handle 12.

A grounded tip thermocouple 34, preferably a type K thermocouple, extends from the tip segment 28 of the shaft member 20. The thermocouple 34 comprises ANSI standard thermocouple wire, composed of two dissimilar metallic wires 36, 38 joined at a thermocouple junction 40. The thermocouple junction 40 and a distal portion of each of the wires 36, 38 are disposed within a sheath 42 having a pointed, solid tip 44. Preferably, the sheath 42 is composed of type 304 stainless steel and has an outside diameter 46 of less than 0.050 inches. The thermocouple 34 has a “grounded tip”. That is, the thermocouple junction 40 is welded to the inner surface of the sheath 42 at the tip 44, substantially commingling a portion of the stainless steel tip material with a portion of the already commingled material of the thermocouple junction 40. The small diameter 46 of the thermocouple 34, combined with the grounded tip, provides the most rapid response time for sensing the temperature at the tip 44, requiring no potting to increase the thermal mass at the measuring junction 40 at the tip 44. The proximal end portion 48 of the sheath 42 is received within the bore 30 at tip segment 28 and mounted to the tip segment 28, preferably by a silver braze, such that solids or liquids may not intrude into bore 30. The thermocouple wires 36, 38 extend through the bore 30 of the shaft member 20, the handle bore 18, and out of an opening 50 in the handle 12 to an ANSI sub-miniature connector (not shown). It should be appreciated that the connector may be connected to any type K thermocouple instrument.

A V-shaped depth stop 52 is preferably composed of type 304 stainless steel and has a foot segment 54 and a mounting segment 56 extending at an angle α therefrom, where α=45 to 135°. The distal end portion 26 of the shaft segment 22 and the tip segment 28 extend through an elliptical opening 58 in the mounting segment 56 and thermocouple 34 extends through a circular opening 60 in the foot segment 54. Preferably, the opening 58 in the mounting segment 56 has notch 62 for receiving the distal end portion 26 of the shaft segment 22, proximate to the tip segment 28. The depth stop 52 is mounted to the shaft segment 22, preferably by a silver braze 64, such that the thermocouple 34 extends through the axis 66 of the opening 60 in the foot segment 54 and such that the tip 44 of the thermocouple 34 is positioned at a predetermined distance D_{c} from the outer surface 68 of the foot segment 54.

Centering the thermocouple 34 in opening 60 ensures that the thermocouple 34 is thermally isolated from the depth stop 52, thereby precluding any possibility that the sensed temperature will be influenced by the temperature of the depth stop 52. It should be appreciated that the thermocouple 34 will be thermally isolated from the depth stop 52 so long as there is a gap therebetween.

The distance D_{c} between tip 44 and surface 68 is determined by the thickness of the meat patty. More specifically, D_{c} is set equal to one-half of the thickness of the meat patty. Accordingly, the patty temperature probe 10 senses the temperature at the center of the meat patty, where the meat has cooked the least. The subject patty temperature probe 10 takes advantage of the uniformity in the physical dimensions of the assembly-line meat patties. That, is the center is always at the same depth for each meat patty prepared to the specifications for the patty. Many fast food restaurants prepare several “lines” of hamburgers, for example a “standard” hamburger and a “quarter pound” hamburger, where beef patty for the quarter pound hamburger is larger than the beef patty the standard hamburger. In this case, the fast food restaurant will have a patty temperature probe 10 for each line of hamburger, where the distance D_{c} for the probe 10 is set for the associated beef patty.

The outer surface 68 of the foot segment 54 has a relatively large surface area, having a width 70 of ⅜ to ⅝ inches and a length 72 of ¾ to 1½ inches. The large surface area, coupled with the angled insertion of the thermocouple 34, ensures that the tip of the thermocouple 34 is inserted to the proper depth and minimizes operator variability when taking patty temperatures.

It should be appreciated that the simple design of the patty temperature probe 10 provides several benefits. The operator simply positions the foot segment 54 of the depth stop 52 over the patty and gently pushes the probe 10 down until the outer surface 68 of the foot segment 54 uniformly contacts the surface of the patty, thereby positioning the tip 44 of the thermocouple 34 at the center of the patty. The thermocouple 34 senses the temperature within seconds and the probe 10 may be removed for use on another patty.

Conventional devices for measuring the temperature at the center of a patty generally include apparatus for determining the location of the patty center. The complexity of such apparatus increases the cost of the device and also makes the device more difficult to clean/sterilize. In addition, personnel may have to be trained in the use of the apparatus or how to determine that the apparatus is not operating properly. Further, these devices generally require the patty to be lifted by the device while determining the center of the patty. The fixed depth stop 52 of the subject invention is less costly to manufacture, is very easy to clean, requires little or no training, cannot malfunction, and does not require moving the patty.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A patty temperature probe comprising:
a handle having oppositely disposed proximal and distal ends;
a shaft member having oppositely disposed proximal and distal end portions and defining a longitudinally extending bore, the proximal end portion of the shaft member being mounted to the distal end of the handle;
a thermocouple including
a sheath having an outer surface and a pointed, solid tip, the sheath extending from the distal end portion of the shaft member and
a thermocouple wire composed of two dissimilar metallic wires joined at a thermocouple junction, the thermocouple junction being disposed within the sheath, the metallic wires extending from the sheath through the bore of the shaft member to an electrical connector; and
a V-shaped depth stop including
a foot segment and
a mounting segment extending at an angle α therefrom,
the foot segment defining an opening having an inner surface, the mounting segment being mounted to the distal end portion of the shaft member, the thermocouple extending through the opening in the foot segment, the outer surface of the sheath and the inner surface of the opening defining an annular gap therebetween.

2. The patty temperature probe of claim 1 wherein the handle is composed of a heat resistant, water impervious material.

3. The patty temperature probe of claim 1 wherein the shaft member includes a cylindrical shaft segment having oppositely disposed proximal and distal ends and a frustoconical-shaped tip segment extending from the distal end of the shaft segment.

4. The patty temperature probe of claim 3 wherein the handle defines a bore extending longitudinally from the distal end of the handle and the proximal end of the shaft segment is fixedly mounted within a distal end portion of the handle bore.

5. The patty temperature probe of claim 4 wherein the shaft member is sealed to the handle to prevent the intrusion of solids or liquids into the handle bore.

6. The patty temperature probe of claim 3 wherein the bore of the shaft member extends longitudinally from the proximal end of the shaft segment to the distal end of the tip segment.

7. The patty temperature probe of claim 3 wherein the shaft member is composed of type 304 stainless steel.

8. The patty temperature probe of claim 3 wherein the sheath of the thermocouple extends from the tip segment of the shaft member.

9. The patty temperature probe of claim 8 wherein a proximal end portion of the sheath is received within the bore of the shaft member at the tip segment and the sheath is mounted to the tip segment by a silver braze.

10. The patty temperature probe of claim 3 wherein the mounting segment of the depth stop also defines an opening, the distal end portion of the shaft segment and the tip segment extending through the opening in the mounting segment.

11. The patty temperature probe of claim 10 wherein the opening in the mounting segment has an elliptical shape and has a notch for receiving the distal end portion of the shaft segment proximate to the tip segment.

12. The patty temperature probe of claim 11 wherein the depth stop is mounted to the shaft segment by a silver braze.

13. The patty temperature probe of claim 1 wherein the thermocouple is a grounded tip thermocouple, a portion of the material of the tip of the sheath commingling with a portion of the material of the thermocouple junction.

14. The patty temperature probe of claim 1 wherein the thermocouple is a type K thermocouple.

15. The patty temperature probe of claim 1 wherein the sheath is composed of type 304 stainless steel and has an outside diameter of less than 0.050 inches.

16. The patty temperature probe of claim 1 wherein the opening in the foot segment is substantially circular, the thermocouple extending through an axis of the opening in the foot segment.

17. The patty temperature probe of claim 16 wherein the tip of the thermocouple is positioned at a predetermined distance D_{c} from an outer surface of the foot segment.

18. The patty temperature probe of claim 16 wherein the depth stop is composed of type 304 stainless steel.

19. The patty temperature probe of claim 16 wherein the foot segment has a width of ⅜ to 5/8 inches and a length of ⅜ to 1½ inches.

20. The patty temperature probe of claim 1 wherein the angle α is 45 to 135°.

21. A patty temperature probe for use with a food patty having a known thickness, the probe comprising:
a handle having oppositely disposed proximal and distal ends;
a shaft member including
a cylindrical shaft segment having oppositely disposed proximal and distal ends and proximal and distal end portions, the proximal end portion of the shaft segment being mounted to the distal end of the handle, and
a frustoconical-shaped tip segment extending from the distal end of the shaft segment,
the shaft member defining a bore extending longitudinally from the proximal end of the shaft segment to a distal end of the tip segment;
a thermocouple including
a sheath having an outer surface and a pointed, solid tip, the sheath extending from the distal end of the tip segment of the shaft member and
a thermocouple wire composed of two dissimilar metallic wires joined at a thermocouple junction, the thermocouple junction being disposed within the sheath and in intimate thermal contact with the tip of the sheath, the metallic wires extending from the sheath through the bore of the shaft member to an electrical connector; and
a V-shaped depth stop including
a mounting segment defining an opening, and
a foot segment extending at an angle α from the mounting segment and defining an opening having an inner surface,
the mounting segment of the depth stop being mounted to the distal end portion of the shaft segment, the thermocouple extending through the opening in the foot segment, the outer surface of the sheath and the inner surface of the opening defining an annular gap therebetween, the tip of the thermocouple being positioned at a predetermined distance D_{c} from an outer surface of the foot segment;
wherein distance D_{c} is substantially equal to one-half of the thickness of the food patty.

22. The patty temperature probe of claim 21 wherein the angle α is 45 to 135°.

23. The patty temperature probe of claim 22 wherein the handle is composed of a heat resistant, water impervious material and the shaft member, the sheath of the thermocouple and the depth stop are composed of type 304 stainless steel.

24. The patty temperature probe of claim 22 wherein the sheath has an outside diameter of less than 0.050 inches.
